(19) United States
(12) Patent Application Publication
(10) Pub. No.: US 2014/0178582 A1
(43) Pub. Date: Jun. 26, 2014

(54) COMPOSITE MEMBRANE FORMED FROM POLYMER BLEND INCLUDING SELF-ASSEMBLING BLOCK COPOLYMERS

(71) Applicants: Scott G. Gaynor, Cary, NC (US); Daniel J. Murray, Midland, MI (US); H. C. Silvis, Midland, MI (US); Yasmin N. Srivastava, Sugar Land, TX (US); Junyan Yang, Lake Jackson, TX (US)

(72) Inventors: Scott G. Gaynor, Cary, NC (US); Daniel J. Murray, Midland, MI (US); H. C. Silvis, Midland, MI (US); Yasmin N. Srivastava, Sugar Land, TX (US); Junyan Yang, Lake Jackson, TX (US)

(73) Assignee: DOW GLOBAL TECHNOLOGIES LLC, Midland, MI (US)

(21) Appl. No.: 14/125,179

(22) PCT Filed: Jul. 26, 2012
(86) PCT No.: PCT/US2012/048217

§ 371 Date: Dec. 10, 2013

Related U.S. Application Data
(60) Provisional application No. 61/526,015, filed on Aug. 22, 2011.

(51) Int. Cl. B01D 29/00

(52) U.S. Cl. CPC B01D 29/0093
USPC 427/245

(57) ABSTRACT

A method for making a composite membrane including the formation of a porous discriminating layer upon a surface of a porous support, including the step of a) forming a polymer blend comprising: i) a “blending” polymer and ii) a block copolymer comprising durable segments that form a co-continuous phase with the blending polymer and fugitive segments that form self-assembled assembled micro-domains within the co-continuous phase, and b) removing at least a portion of the fugitive segments to yield pores having an average size of ≦0.5 μm.

### FIELD OF THE INVENTION

The present invention is directed toward a composite membrane including a porous support and a discriminating layer.

### DESCRIPTION OF THE RELATED ART

Composite membranes include a selective barrier or “discriminating layer” disposed upon a porous support. While the support provides the membrane with mechanical integrity, it offers little resistance to flow. In most applications, the primary means of separation is provided by the discriminating layer. As such, it is important that the discriminating layer remain fixed to the surface of the support.

Self-assembling block copolymers have been used to form thin films for various applications including lithography. The block copolymer includes durable segments that form a continuous phase and fugitive segments that form self-assembled micro-domains. The fugitive segments are subsequently etched away to form relatively uniform, mono-dispersed, nano-sized pores. Examples of such films are described in: U.S. Pat. No. 4,0960,99, U.S. Pat. No. 7,347,953, U.S. Pat No. 7,572,669, U.S. Pat. No. 7,964,107, US 2008/0230514, US 2009/0200646 and JP 11-080414. Self-assembling block copolymers have also been considered in membrane-related applications. Examples are described in: U.S. Pat. No. 7,438,193, US 2009/0208842, US 2009/0239381, US 2010/0292077 and US 2010/0036009. To be useful as a discriminating layer of a composite membrane, the discriminating later must form a strong union with the support. This requirement limits the applicability of self-assembling block copolymers in composite membrane applications—particularly those involving high pressure operating conditions such as microfiltration (MF), ultrafiltration (UF), nanofiltration (NF) and reverse osmosis (RO).

### BRIEF SUMMARY OF THE INVENTION

The present invention includes composite membranes and methods for making the same including the formation of a porous discriminating layer upon a surface of a porous support. The method includes the step of forming a polymer blend comprising: i) a “blending” polymer and ii) a block copolymer comprising durable segments that form a co-continuous phase with the blending polymer, and fugitive segments that form micro-domains within the co-continuous phase. At least a portion of the fugitive segments are removed to yield pores having an average size of ≦0.5 μm. The subject membranes are useful in a wide variety of applications including but not limited to traditional ultrafiltration, e.g. drinking water pre-treatment and waste water reuse. Many different embodiments are described.

### DETAILED DESCRIPTION OF THE INVENTION

In one embodiment the invention includes a method for making a composite membrane including the steps of: a) providing a porous support comprising a first polymer, and b) forming a porous discriminating layer upon a surface of the porous support. The type of support utilized is not particularly limited and various configurations (e.g. flat sheet, disc, hollow fiber, tubular, porous fiber, etc.) and compositions (e.g. polyvinylidene fluoride (PVDF); polyolefins including polyethylene and polypropylene; poly(aryl ethers) including poly(aryl ether) sulfones, ketones, phosphine oxides and nitriles, polyamides, etc.), including homopolymers, copolymers and polymer blends may be used. Techniques for creating porosity within the support are not particularly limited and include phase inversion (e.g. thermally induced, diffusion induced, etc.) and track-etching. In preferred embodiments, the surface of the support has an average surface pore size of ≧0.1 μm, (e.g. from 0.1 to 10 μm and more preferably from 0.5 to 5 μm). While various methods may be used to determine pore size, one preferred technique is size averaging of at least 10 but preferable 100 randomly selected pores using scanning electron microscopy over a field of 1 μm×1 μm of the surface. The support may be isotropic or anisotropic (e.g. Loeb-Sourirajan type or multi-layer composite-type). If the support includes multiple layers, the layers may include dissimilar compositions and/or porosities. However, for purposes of the present description, the principle focus shall be the composition of the surface of the support upon which the discriminating layer is coated. Examples of applicable supports include porous polymeric membranes commonly used in micro and ultrafiltration. Commercially available supports can be obtained from a wide variety of membrane producers including: Asahi, Koch, Memcor, Millipore, Norit and Pall.

The polymer used to form the support (or at least the region of the support comprising the surface of interest), i.e. “first polymer,” includes a plurality of repeat units, each of which comprising at least one structure unit. The term “structural unit” refers to the result of a monomer that has been polymerized into a polymer chain. There may be more than one structure unit within a repeat unit. The term “polymer” includes both homopolymers and copolymers. The term “copolymer” refers to a polymer comprising more than one type of repeat unit. A preferred class of polymers used in preparing the support includes at least 50 (and more preferably ≧75 and in some applications ≧90) molar percent of repeat units including a structural unit represented by Formula (I):

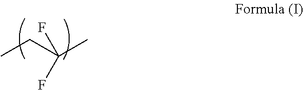

This class includes homo, co-polymers and blends of polyvinylidene fluoride, e.g. polymers having a repeat unit represented by Formula (I). Representative examples are described in: U.S. Pat. No. 5,022,990, U.S. Pat. No. 6,074,718, US 2008/0210624, US 2011/0017661 and WO 2010/051150. Polyvinylidene fluoride polymers having weight average molecular weights (Mw) of from 100,000 to 10,000,000 Daltons are preferred and molecular weights (Mw) of about 200,000 to 600,000 Daltons are still more preferred.

Another preferred class of suitable polymers includes those wherein at least 50 (and more preferably ≧75 and in some applications ≧90) molar percent of the repeat units include a structural unit represented by Formula (II):

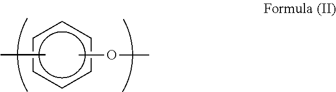

This class includes homo, co-polymers and blends of poly(aryl ethers), including but are not limited to poly(aryl ether) sulfones, ketones, phosphine oxides and nitriles. The Mw of poly(aryl ethers) is not particularly limited but is preferably from 30,000 to 200,000 Daltons. A preferred subclass of poly(aryl ethers) comprises a structural unit represented by Formula (III):

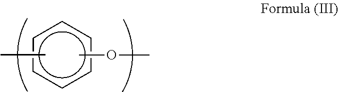

Another preferred subclass of poly(aryl ethers) comprise polysulfones, including species comprising a structural unit represented by Formula (IV):

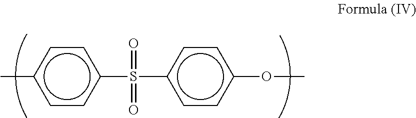

Representative repeat units of applicable polysulfones are illustrated by Formulae (V-X):

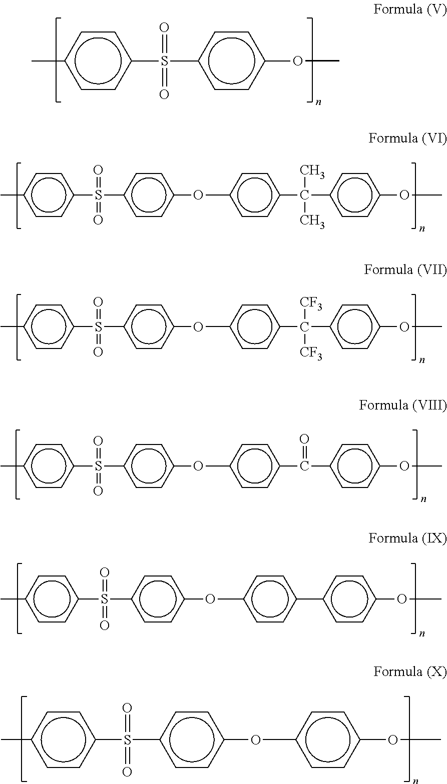

Another subclass of preferred poly(aryl ethers) comprises poly(ether ether ketones), including species comprising a structural unit represented by Formula (XI):

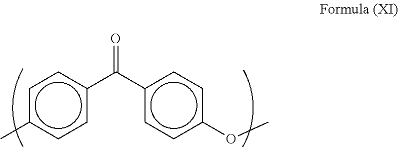

Yet another subclass of preferred poly(aryl ethers) comprises poly(aryl ether) phosphine oxides including species comprising a structural unit represented by Formula (XII).

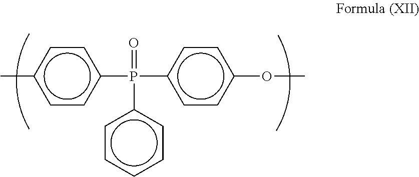

Still another subclass of preferred poly(aryl ethers) comprises poly(aryl ether) nitriles including species comprising a repeat unit comprising a subunit represented by Formula (XIII).

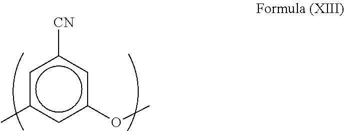

The present method includes the step of forming a porous discriminating layer upon a surface of the porous support. This step includes forming a polymer blend comprising: i) a second polymer (i.e. “blending polymer”) and ii) a block copolymer. The second polymer includes a plurality of repeat units each comprising at least one structure unit, wherein at least 50 mole percent of repeat units of the second and first polymers include a common structural unit (e.g. preferably those represented by Formula I or II). In several preferred embodiments, at least 50, 75, 90 and even 100 mole percent of the repeat units of the first and second polymers are the same (although the Mw of the first and second polymers may be different). Non-limiting examples include the species of polymers previously described with respect to the first polymer, including homo and copolymers of polyvinylidene fluoride (e.g. Kynar™ FLEX 2801 available from Arkema Group) and poly(aryl ethers).

The polymer blend further includes a block copolymer comprising durable segments capable of forming a co-continuous phase with the second polymer and fugitive segments that form self assembled micro-domains (e.g. cylindrical, gyroidal, asymmetric, etc.) within the co-continuous phase. For purposes of the present description, the term “block copolymer” refers to a polymer comprising two or more dissimilar polymer (e.g. homopolymer, copolymer) segments linked by covalent bonds. The union of the dissimilar segments may optionally include an intermediate non-repeat subunit, commonly referred to as a junction block. The block copolymer used in the present invention may contain any numbers of the polymeric block segments arranged in any manner (e.g. di-block, tri-block, multi-blocks, branched block, graft, linear star polymers, comb block copolymers, gradient polymers, etc.). The block copolymer may have a linear or branched structure. Non-limiting examples of applicable block copolymers are illustrated by the following formulae:

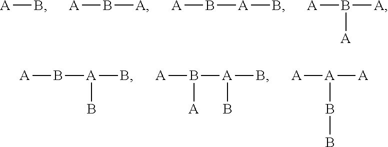

In a preferred embodiment, the durable segments are immiscible with the fugitive segments but are capable of forming a co-continuous phase with the second polymer used to form the blend. Thus, the selection of the durable segments will depend upon the selection of the second polymer and fugitive segments. By way of non-limiting examples, many polyacrylates form co-continuous phases with polyvinylidene fluoride (PVDF), e.g. poly(methyl methacrylate) (PMMA), poly(ethyl methacrylate) (PEMA), poly(methyl acrylate) (PMA), poly(ethyl acrylate) (PEA) and poly(isopropyl acrylate). Addition non-limiting examples of non-acrylates include: poly(vinyl acetate) (PVA), poly(vinyl methyl ketone) (PVMK), poly(caprolactone), poly(tetramethylene adipate) (PTMA), poly (1,4-butylene adipate), poly(trimethyllene adipate) (PTA), poly(pentamethyllene adipate) (PPA), poly(3-hydroxybutyrate) (PHB), polyacrylonitrile (PAN) (partially miscible) and polyvinylpyrrolindone (PVP). PVP and polyethylene oxides (PEO) may also be used as durable segments with polysulfones and polyether sulfones (PES). Polyimide, polyaramide and polyether ether ketone (PEEK) may be used with PES as can polyhydroxyethers of bisphenol-A(phenoxy) and phenolphthalein.

The fugitive segment should be capable of forming self-assembled, periodic nano-sized micro-domains (e.g. cylindrical, gyroidal, etc.) within the blend and should be capable of being at least partially removed, i.e. etched away, to yield pores having an average size ≦0.5 μm, more preferably ≦0.1 μm, and in some applications ≦0.05 μm, (as measured by capillary flow poropmeter, e.g. ASTM F316-03 (2011). Techniques for removal the fugitive segment are not particularly limited and examples include exposure to acid, base, ozone and irradiation. By way of example, polylactic acid (PLA) is immiscible with PMMA and is easily removed (etched) away by washing with mild base. Thus, in one preferred embodiment, the first and second polymers comprise homo or copolymers of PVDF and the block copolymer comprises PMMA segments along with PLA segments. Additional non-limiting examples include: PMMA-b-polyglycolic acid, PMMA-b-polycaprolactone, PMMA-b-poly (β-butyrolactone) and PMMA-b-poly(ethylene oxide). Still additional examples include: polysulfone-poly(ethylene terephthalate), polysulfone-poly(hydroxybenzoate), poly(ethylene oxide)- polysulfone (PEO-PS), polysulfone—poly(dimethylsiloxane). A wide variety of additional polymer blends and block copolymers are applicable to the present invention and are described in the references cited herein.

The specific shape of the self-assembled micro-domains can be modified by varying the overall molecular weight and weight ratios of the durable and fugitive segments. For most applications, a weight ratio of durable to fugitive segment is from about 1:6 to 2:1, and more commonly from about 1:3 to 1:1. In many embodiments, a preferred micro-domain shape comprises perpendicularly oriented cylinders (i.e. perpendicular to the support).

The polymer blend preferably comprises a weight ratio of the second polymer to the block copolymer of from about 1:9 to 9:1, and in some embodiments from about 1:3 to 3:1, or from about 1:2 to 2:1. The polymer blend may also include minor portions (e.g. less than about 10 wt. % of total weight) of addition constituents.

The method for forming the polymer blend is not particularly limited and includes a wide variety of techniques including melt extrusion and solvent casting where the second polymer and block copolymer are combined with an appropriate solvent mixture (e.g. as 1 to 10 wt.% solution). The resulting mixture may be coated upon a surface of the support such as by way of dip coating, spin coating, die coating, slot coating, etc. In preferred embodiments, the polymer blend is coated directly upon the support without the use of sacrificial substrates or coupling agents, (e.g. no use glass, silica, silica containing coupling agents, etc.).

Once coated upon the support, the fugitive segments are removed. Techniques for removal the fugitive segment are not particularly limited and non-limiting examples include exposure to acid, base, ozone and irradiation. The resulting discriminating layer is preferably relatively thin as compared with the support, e.g. ≦5 μm, (e.g. from about 0.1 to 5 μm, and more preferably from about 0.5 to 2 μm).

### Examples

Several composite membranes were prepared by obtaining equivalent commercially available PVDF hollow fiber membrane supports having average surface pore sizes of approximately 0.3 μm. The supports were pre-wetted with ethanol and briefly immersed in water. Excess water was removed and the supports were dipped into various coating solutions for approx. one minute. The coating solutions each included a blend of Kynar™ FLEX 2801 (PVDF) and a block copolymer (PMMA-b-PLA) in a 1:1 weight ratio, as a 8 wt % solution in methyl ethyl ketone (MEK). Several coating compositions were used, including block copolymers extending over a range of molecular weights and weight ratios, e.g. Mn (g/mol) from approx. 15,000 to 55,000 and weight ratios (PMMA:PLA) of approx. 1:1 to 5.5:1. The supports were removed from the coating solution and residual solvent on the support was allowed to evaporate for approx. 30 seconds prior to being placed in an oven at 60° C. for approx. 20 minutes. Thereafter the oven temperature was reduced to 30° C. where the coated supports remained for approximately 12 hours. The coated support was then annealed within a vacuum oven for approx. 12 hours at 110 to 145° C. Thereafter, the supports were immersed in a solution of 0.5 M NaOH in 60/40 (v/v) methanol/H₂O at room temperature for approx. 3.5 hours. The resulting composite membranes were rinsed with methanol followed by deionized water and then air dried for approx. 12 hours.

SEM analysis revealed that the discriminating layers of the supports had thicknesses of from 0.7 to 1.2 μm with uniformly dispersed and sized pores having an average pore size of from 0.020 to 0.050 μm. When subject to testing using pure water at 100 kPa and 20° C., the discriminating layer remained tightly bound to the support.

A second series of composite membranes were prepared and tested. Except where noted, the methodology and materials were the substantially similar to those previously described. PVDF hollow fiber membrane supports were pre-wetted with polyethylene glycol at approx. 60° C. for 15 minutes and then air dried at room temperature. Individual supports were dip coated with various block copolymer solutions as specified in Table 1. The coating solutions each included a block copolymer (PMMA-b-PLA) in a 1:1 weight ratio as 11-15 wt % solution in methyl ethyl ketone (MEK). The coated supports with then annealed followed by immersion in a solution of 0.2 M NaOH in 60/40 (v/v) methanol/H₂O at room temperature for approx. 17 hours. The resulting composite membranes were rinsed with methanol followed by deionized water and then air dried at room temperature for approx. 14 hours. The membranes were exampled via SEM and subject to conventional testing to determine flux, bubble point and backpressure testing. As summarized in Table 1, sample membranes including a discriminating layer with a second or “blending” polymer (PVDF) had reduced coating defects (higher bubble point values) and improved adhesion (higher back pressures prior to delamination of discriminating layer). These results were consistent with SEM analysis which revealed more uniform coating coverage and thicknesses associated with coating solutions including PVDF

TABLE 1

| | PVDF/PMMA-PLA & | | Bubble point | Backwash |
|---|---|---|---|---|
| Coating | PMMA/PLA wt. ratios, | Flux | (PSI) for | pressure (PSI) |
| Solution | PMMA/PLA (Mn) | (LMH) | coating defects | for adhesion |
| PMMA-PLA | N/A, 24:76, (90k) | 1018 | 45 | 33 |
| PVDF/PMMA-PLA | 50:50, 24:76, (90k) | 642 | 51 | >59 |
| PVDF/PMMA-PLA | 30:70, 40:60, (62k) | 1119 | 47 | ~52 |
| PVDF/PMMA-PLA | 40:60, 40:60, (62k) | 747 | 48 | >57 |
| PVDF/PMMA-PLA | 50:50, 40:60, (62k) | 480 | 48 | >58 |
| PVDF/PMMA-PLA | 60:40, 40:60, (62k) | 105 | 55 | >58 |

The use of first and second polymers sharing common structural units is believed to significantly improve adhesion between the porous support and the discriminating layer. While not wishing to be bound by theory, the selection of solvent or use of high temperature when coating a melted polymer blend is also believe to contribute to improved bonding between the support and discriminating layer. Such adhesion is particularly important in high pressure applications.

Many embodiments of the invention have been described and in some instances certain embodiments, selections, ranges, constituents, or other features have been characterized as being “preferred.” Characterizations of “preferred” features should in no way be interpreted as deeming such features as being required, essential or critical to the invention. Stated ranges include end points.

The entire subject matter of each of the aforementioned patent documents is incorporated herein by reference.

What is claimed is:

1. A method of making a composite membrane comprising the steps of:
a) providing a porous support comprising a first polymer including a plurality of repeat units each comprising at least one structure unit; and
b) forming a porous discriminating layer upon a surface of the porous support, characterized by:
forming a polymer blend comprising:
i) a second polymer including a plurality of repeat units each comprising at least one structure unit, and wherein at least 50 mole percent of repeat units of the first and second polymers include a common structural unit, and
ii) a block copolymer comprising durable segments that form a co-continuous phase with the second polymer, and fugitive segments that form micro-domains within the co-continuous phase; and
removing at least a portion of the fugitive segments to yield pores having an average size of ≦5 μm.

2. The method of the previous claim wherein the first and second polymers comprise at least 50 molar percent of repeat units including a structural unit selected from at least one of:

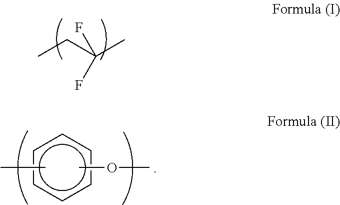

3. The method of any of the preceding claims wherein the first and second polymers comprising at least 50 mole percent of common repeat units.

4. The method of any of the preceding claims wherein the first polymer comprises a homo or co-polymer of polyvinylidene fluoride.

5. The method of any of the preceding claims wherein the weight ratio of the second polymer to block copolymer is from 1:9 to 9:1.

6. The method of any of the preceding claims wherein the molecular weight ratio of the durable segments to fugitive segments is from 1:6 to 2:1.
